(19) United States
(12) Patent Application Publication
(10) Pub. No.: US 2012/0075263 A1
(43) Pub. Date: Mar. 29, 2012

(54) DRIVING CIRCUIT AND OPERATING METHOD THEREOF

(76) Inventors: Ko-Yang Tso, New Taipei City (TW); Chi-Yuan Lu, Zhongpu Township (TW); Chin-Chieh Chao, Hsinchu City (TW); Yu-Lung Lo, New Taipei City (TW)

(21) Appl. No.: 13/215,770

(22) Filed: Aug. 23, 2011

(30) Foreign Application Priority Data
Sep. 24, 2010 (TW) 099132405

(51) Int. Cl. G06F 3/038

(52) U.S. Cl. 345/204

(57) ABSTRACT

A driving circuit and an operating method thereof are disclosed. The driving circuit includes at least one first channel, at least one second channel, a selecting module, and at least one switching module. The selecting module is coupled to input ends of the first channel and the second channel. The at least one switching module is coupled to output ends of the at least one first channel and the at least one second channel. The selecting module and the switching module will perform corresponding switching actions to make the driving circuit selectively under a first operating mode or a second operating mode.

### BACKGROUND OF THE INVENTION

1. Field of the Invention

The invention relates to a driving circuit, in particular, to a driving circuit and operating method thereof applied in a LCD apparatus.

2. Description of the Prior Art

In recent years, with the continuous progress of display technology, various types of display apparatuses, such as a LCD display and a plasma display, are shown in the market. Because the volume of the LCD display is much smaller the conventional CRT display, the LCD display using smaller desk space is convenient for the people in modern life.

In general, the driving apparatus of the TFT-LCD display mainly includes a source driving circuit and a gate driving circuit. For the TFT-LCD display having high quality, high resolution, and low power consumption, the source driving circuit plays a very important role. Please refer to FIG. 1. FIG. 1 illustrates a schematic figure of the structure of the conventional source driving circuit.

As shown in FIG. 1, the source driving circuit 1 includes a first data line L1˜a sixth data line L6 and a first channel C1˜a sixth channel C6, wherein the first channel C1 is coupled to the first data line L1; the second channel C2 is coupled to the second data line L2; the third channel C3 is coupled to the third data line L3; the fourth channel C4 is coupled to the fourth data line L4; the fifth channel C5 is coupled to the fifth data line L5; the sixth channel C6 is coupled to the sixth data line L6.

Taking the first channel C1 of the source driving circuit 1 for example, after a first data latching module C11 in the first channel C1 receives a high-speed first digital data signal S1 from the first data line L1, the first digital data signal S1 will in order processed by a second data latching module C12, a level shift module C13, and a CMOS digital-to-analog converter (DAC) C14 in the first channel C1, and then amplified by an OP amplifier C15 to form a first analog signal S1′ and transmitted to a LCD display panel 2. In addition, since the operations of the second channel C2 through the sixth channel C6 of the source driving circuit 1 are similar to the above-mentioned operation of the first channel C1, they will not be introduced again here.

However, it should be noticed that a CMOSFET is used in the CMOS DAC C14 of the conventional source driving circuit 1; therefore, the area of the CMOS DAC C14 is much larger than the area of the DAC formed by NMOSFET or PMOSFET, so that the channel density of the conventional source driving circuit 1 is limited and hard to be increased.

Therefore, the invention provides a driving circuit and operating method thereof to solve the above-mentioned problems.

### SUMMARY OF THE INVENTION

A first embodiment of the invention is a driving circuit. In this embodiment, the driving circuit includes at least one first channel, at least one second channel, a selecting module, and at least one switching module. The selecting module is coupled to input ends of the first channel and the second channel. The at least one switching module is coupled to output ends of the at least one first channel and the at least one second channel. The selecting module and the switching module perform corresponding switching actions to make the driving circuit selectively under a first operating mode or a second operating mode.

When the driving circuit is under the first operating mode, the selecting module inputs a first data signal to the first channel and inputs a second data signal to the second channel; when the driving circuit is under the second operating mode, the selecting module inputs a first data signal to the second channel and inputs a second data signal to the first channel.

In addition, the driving circuit can further include a first amplifier and a second amplifier coupled to the switching module.

When the driving circuit is under the first operating mode, the switching module switches the output end of the first channel to the first amplifier and switches the output end of the second channel to the second amplifier, the switching module transmits the first data signal outputted from the output end of the first channel to the first amplifier, and transmits the second data signal outputted from the output end of the second channel to the second amplifier.

When the driving circuit is under the second operating mode, the switching module switches the output end of the first channel to the second amplifier and switches the output end of the second channel to the first amplifier, the switching module transmits the second data signal outputted from the output end of the first channel to the second amplifier, and transmits the first data signal outputted from the output end of the second channel to the first amplifier. In fact, the selecting module can be formed by a plurality of multiplexers.

A second embodiment of the invention is a driving circuit operating method. In this embodiment, the driving circuit includes at least one first channel, at least one second channel, a selecting module, and at least one switching module. The selecting module is coupled to input ends of the first channel and the second channel; the at least one switching module is coupled to output ends of the at least one first channel and the at least one second channel.

The driving circuit operating method includes steps of: receiving a control signal; the selecting module and the switching module perform corresponding switching actions according to the control signal; the driving circuit selectively under a first operating mode or a second operating mode.

When the driving circuit is under the first operating mode, the method further includes steps of: the selecting module inputting a first data signal to the first channel and inputting a second data signal to the second channel; the switching module switching the output end of the first channel to a first amplifier and switching the output end of the second channel to a second amplifier; the switching module transmitting the first data signal outputted from the output end of the first channel to the first amplifier, and transmitting the second data signal outputted from the output end of the second channel to the second amplifier.

When the driving circuit is under the second operating mode, the method further includes steps of: the selecting module inputting a first data signal to the second channel and inputting a second data signal to the first channel; the switching module switching the output end of the first channel to a second amplifier and switching the output end of the second channel to a first amplifier; the switching module transmitting the second data signal outputted from the output end of the first channel to the second amplifier, and transmitting the first data signal outputted from the output end of the second channel to the first amplifier.

Compared to the prior arts, since N-type and P-type DAC modules with smaller area can be used in each channel of the driving circuit of the invention, the conventional CMOS DAC module with larger area can be replaced to largely reduce the area used by each channel to increase the channel density of the driving circuit.

In addition, it is unnecessary to dispose the N-type DAC module and the P-type DAC module with different polarities in two adjacent channels in the driving circuit respectively. The switching module can exchange the data signals only if the channels corresponding to the data signals have different polarities respectively. Therefore, the alignment freedom of the N-type DAC modules and the P-type DAC modules in each channel can be also increased in the driving circuit of the invention.

The advantage and spirit of the invention may be understood by the following detailed descriptions together with the appended drawings.

### BRIEF DESCRIPTION OF THE APPENDED DRAWINGS

FIG. 1 illustrates a schematic figure of the structure of the conventional source driving circuit.

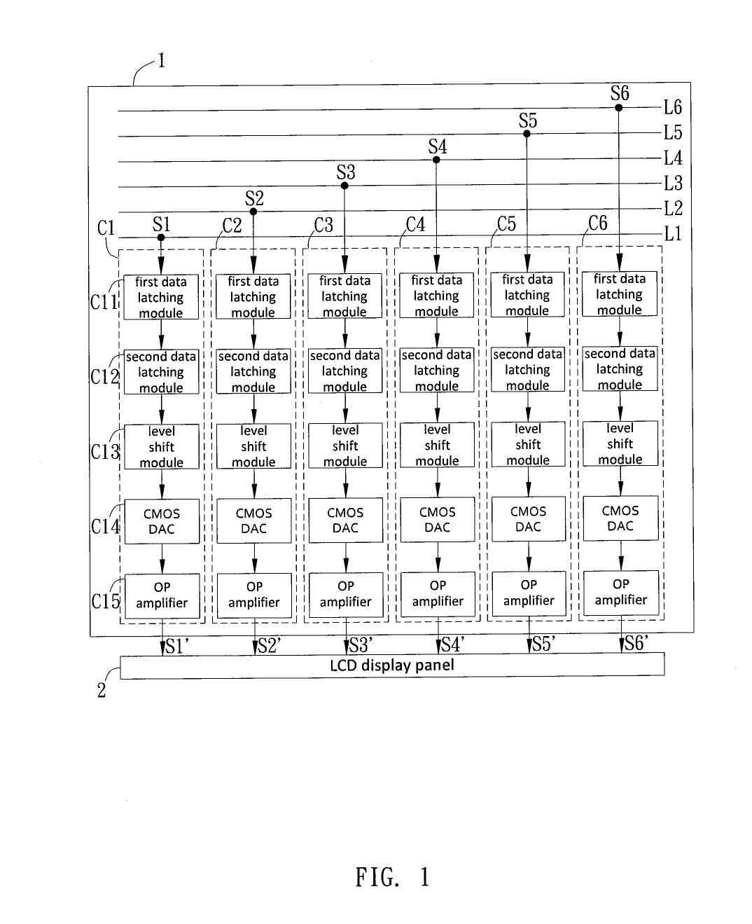

FIG. 2 illustrates a functional block diagram of the driving circuit operated under a first operating mode in the first embodiment of the invention.

FIG. 3 illustrates a functional block diagram of the driving circuit operated under a second operating mode in the first embodiment of the invention.

FIG. 4 illustrates an example of the selecting module.

FIG. 5 illustrates an example of the driving circuit.

FIG. 6 illustrates a flowchart of the driving circuit operating method in the second embodiment of the invention.

FIG. 7 illustrates a flowchart of the driving circuit operating method when the driving circuit is operated under the first operating mode.

FIG. 8 illustrates a flowchart of the driving circuit operating method when the driving circuit is operated under the second operating mode.

### DETAILED DESCRIPTION OF THE INVENTION

A first embodiment of the invention is a driving circuit. In this embodiment, the driving circuit can be a source driving circuit applied in a TFT-LCD display, but not limited to this case.

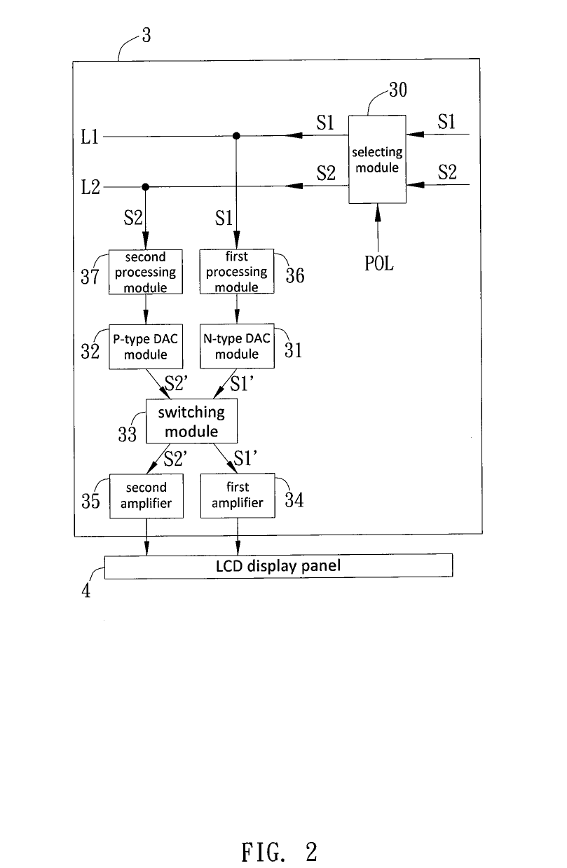

Please refer to FIG. 2. FIG. 2 illustrates a functional block diagram of the driving circuit operated under a first operating mode in this embodiment. As shown in FIG. 2, the driving circuit 3 is coupled to a LCD display panel 4. The driving circuit 3 includes a selecting module 30, an N-type DAC module 31, a P-type DAC module 32, a switching module 33, a first amplifier 34, a second amplifier 35, a first processing module 36, a second processing module 37, a first data line L1, and a second data line L2.

Wherein, the selecting module 30 is coupled to the first data line L1 and the second data line L2; the N-type DAC module 31 and the P-type DAC module 32 are coupled to the first processing module 36 and the second processing module 37 respectively; the first processing module 36 is coupled to the first data line L1; the second processing module 37 is coupled to the second data line L2; the switching module 33 is coupled to the N-type DAC module 31, the P-type DAC module 32, the first amplifier 34, and the second amplifier 35; the first amplifier 34 and the second amplifier 35 are coupled to the LCD display panel 4. Wherein, the first processing module 36 and the second processing module 37 respectively include a first data latching unit, a second data latching unit, and a level shift unit. Since their functions are well-known, so they will not be mentioned again here.

As shown in FIG. 2, when the driving circuit 3 is operated under the first operating mode according to a control signal POL, the selecting module 30 will not perform any exchange on the first digital data signal S1 of the first data line L1 and the second digital data signal S2 of the second data line L2. Therefore, the first processing module 36 coupled to the first data line L1 receives the first digital data signal S1, and the second processing module 37 coupled to the second data line L2 receives the second digital data signal S2.

Then, the N-type DAC module 31 converts the first digital data signal S1 into a first analog data signal S1′ and transmits the first analog data signal S1′ to the switching module 33; the P-type DAC module 32 converts the second digital data signal S2 into a second analog data signal S2′ and transmits the second analog data signal S2′ to the switching module 33. Because the selecting module 30 does not perform any data signal exchange under the first operating mode, the switching module 33 will not perform any data signal exchange correspondingly. Therefore, the switching module 33 will switch the N-type DAC module 31 to be coupled to the first amplifier 34, and switch the P-type DAC module 32 to be coupled to the second amplifier 35, so that the first analog data signal S1′ can be smoothly transmitted to the first amplifier 34, and the second analog data signal S2′ can be smoothly transmitted to the second amplifier 35. Afterward, the first analog data signal S1′ and the second analog data signal S2′ will be amplified by the first amplifier 34 and the second amplifier 35 respectively, and then the amplified first analog data signal S1′ and second analog data signal S2′ will be transmitted to the LCD display panel 4.

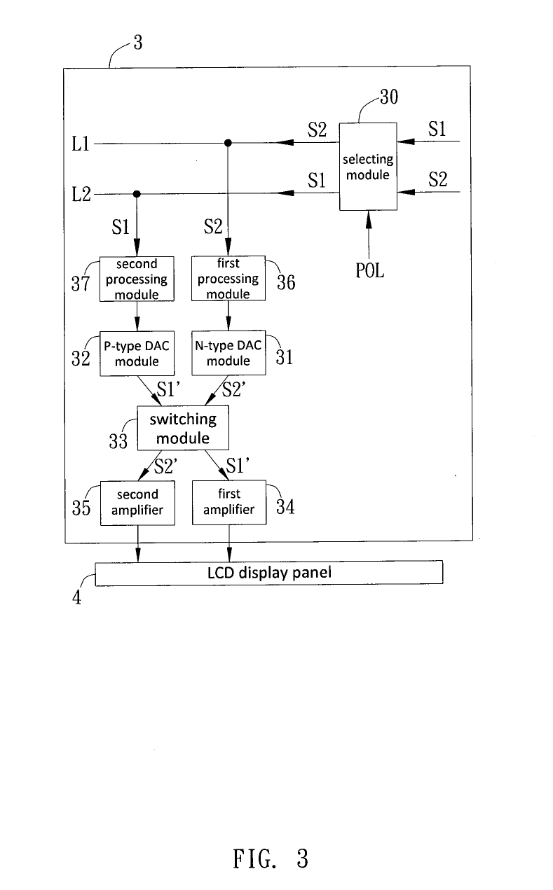

Next, please refer to FIG. 3. FIG. 3 illustrates a functional block diagram of the driving circuit operated under a second operating mode in this embodiment. As shown in FIG. 3, the driving circuit 3 is coupled to the LCD display panel 4. The driving circuit 3 includes the selecting module 30, the N-type DAC module 31, the P-type DAC module 32, the switching module 33, the first amplifier 34, the second amplifier 35, the first processing module 36, the second processing module 37, the first data line L1, and the second data line L2. Wherein, the first processing module 36 and the second processing module 37 respectively include the first data latching unit, the second data latching unit, and the level shift unit. Since their functions are well-known, so they will not be mentioned again here.

It should be noticed that when the driving circuit 3 is operated under the second operating mode according to the control signal POL, the selecting module 30 will perform an exchange on the first digital data signal S1 of the first data line L1 and the second digital data signal S2 of the second data line L2. That is to say, the data signals are exchanged by the selecting module 30. Therefore, the first processing module 36 coupled to the first data line L1 receives the second digital data signal S2, and the second processing module 37 coupled to the second data line L2 receives the first digital data signal S1.

Then, the N-type DAC module 31 converts the second digital data signal S2 into a second analog data signal S2′ and transmits the second analog data signal S2′ to the switching module 33; the P-type DAC module 32 converts the first digital data signal S1 into a first analog data signal S1′ and transmits the first analog data signal S1′ to the switching module 33. Because the selecting module 30 performs data signal exchange on the first digital data signal S1 and the second digital data signal S2 under the second operating mode, the switching module 33 will also perform data signal exchange on the first analog data signal S1′ and the second analog data signal S2′ correspondingly. At this time, the switching module 33 will switch the N-type DAC module 31 to be coupled to the second amplifier 35, and switch the P-type DAC module 32 to be coupled to the first amplifier 34, so that the first analog data signal S1′can be smoothly transmitted to the first amplifier 34, and the second analog data signal S2′ can be smoothly transmitted to the second amplifier 35. Afterward, the first analog data signal S1′ and the second analog data signal S2′ will be amplified by the first amplifier 34 and the second amplifier 35 respectively, and then the amplified first analog data signal S1′ and second analog data signal S2′ will be transmitted to the LCD display panel 4.

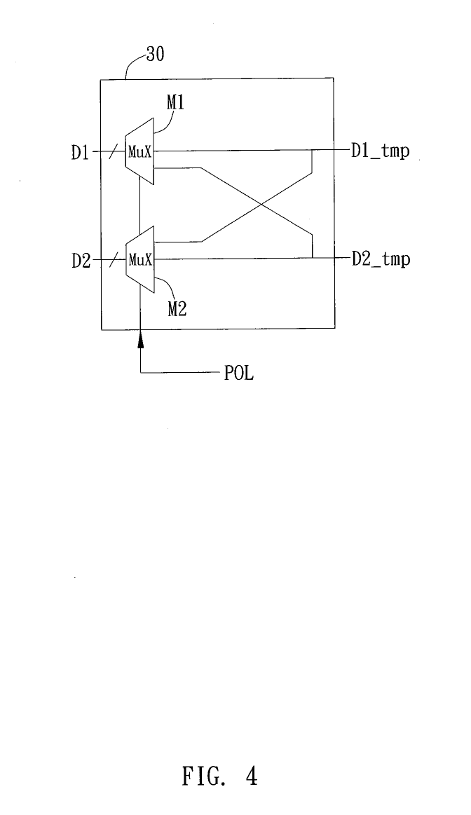

In practical applications, the selecting module 30 can be formed by a plurality of multiplexers. Please refer to FIG. 4. FIG. 4 illustrates an example of the selecting module 30. As shown in FIG. 4, the selecting module 30 is formed by a first multiplexer M1 and a second multiplexer M2, and used to selectively exchange digital data signals according to the control signal POL. In this embodiment, the digital data signals inputted to the selecting module 30 are D1_tmp and D2_tmp respectively, and the digital data signals outputted from the selecting module 30 are D1 and D2. It should be noticed that FIG. 4 only shows an example of the selecting module 30 of the invention; it is not limited to this case.

In addition, in the driving circuit of the invention, the switching module can exchange the data signals only if the channels corresponding to the data signals have different polarities respectively, that is to say, it is unnecessary to dispose the N-type DAC module and the P-type DAC module with different polarities in two adjacent channels in the driving circuit respectively. Therefore, the alignment freedom of the N-type DAC modules and the P-type DAC modules in each channel can be also increased in the driving circuit of the invention.

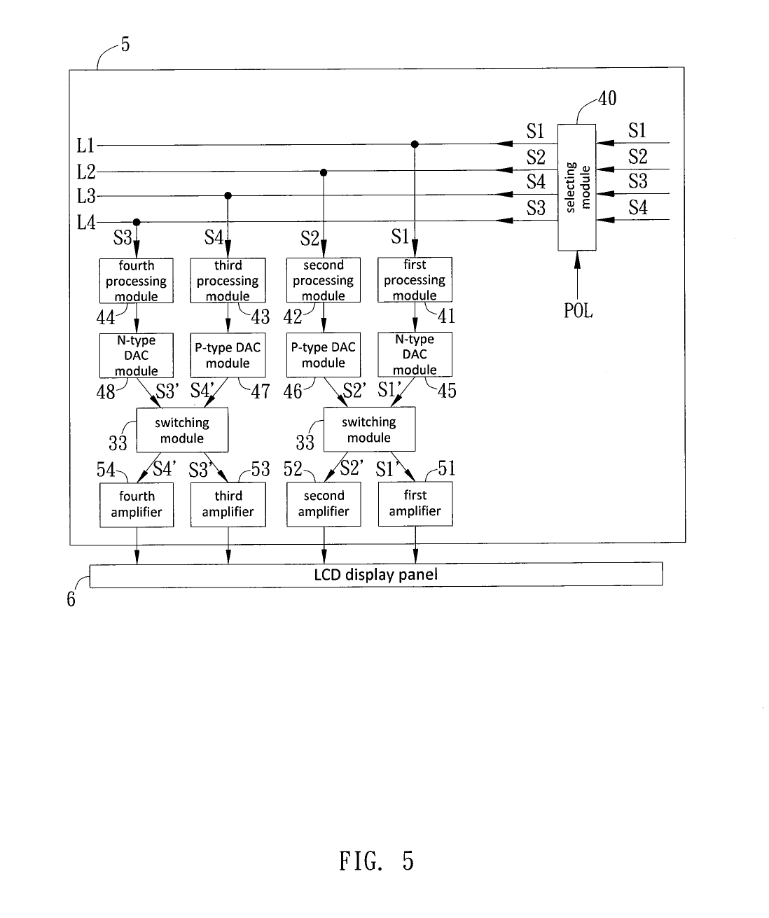

For example, a shown in FIG. 5, the P-type DAC modules 46 and 47 in two adjacent channels of the driving circuit 5 have the same polarity, however, since the P-type DAC module 46 is switched by a first switching module 49 to exchange data signals with the N-type DAC module 45, and the P-type DAC module 47 is switched by a second switching module 50 to exchange data signals with the N-type DAC module 48. Therefore, even the P-type DAC modules 46 and 47 in two adjacent channels of the driving circuit 5 have the same polarity, the driving circuit 5 can smoothly perform exchange of the data signals. It should be noticed that FIG. 5 is only an example of the driving circuit in the invention, the alignment of the N-type DAC modules and the P-type DAC modules of each channel of the driving circuit is not limited to this case.

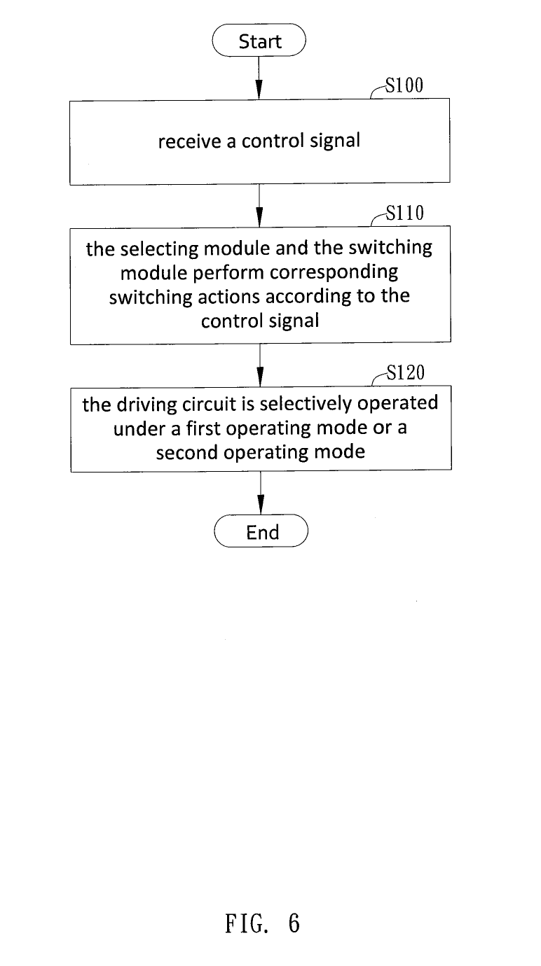

A second embodiment of the invention is a driving circuit operating method. In this embodiment, the driving circuit includes at least one first channel, at least one second channel, a selecting module, and at least one switching module. The selecting module is coupled to input ends of the first channel and the second channel; the at least one switching module is coupled to output ends of the at least one first channel and the at least one second channel. Please refer to FIG. 6. FIG. 6 illustrates a flowchart of the driving circuit operating method in this embodiment.

As shown in FIG. 6, at first, in step S100, the method receives a control signal. Then, in the step S110, the selecting module and the switching module perform corresponding switching actions according to the control signal. Afterward, in step S120, the driving circuit is selectively operated under a first operating mode or a second operating mode.

Then, the condition that the driving circuit is selectively operated under the first operating mode or the second operating mode will be discussed respectively.

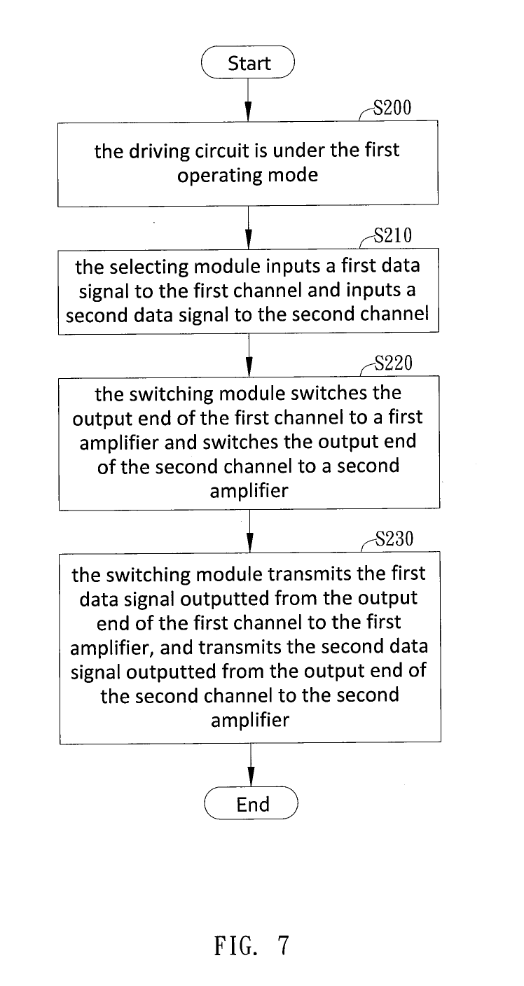

Please refer to FIG. 7. FIG. 7 illustrates a flowchart of the driving circuit operating method when the driving circuit is operated under the first operating mode. As shown in FIG. 7, when the driving circuit is under the first operating mode (step S200), the method performs step S210 that the selecting module inputs a first data signal to the first channel and inputs a second data signal to the second channel. Then, the method performs step S220 that the switching module switches the output end of the first channel to a first amplifier and switches the output end of the second channel to a second amplifier. Afterward, the method performs step S230 that the switching module transmits the first data signal outputted from the output end of the first channel to the first amplifier, and transmits the second data signal outputted from the output end of the second channel to the second amplifier.

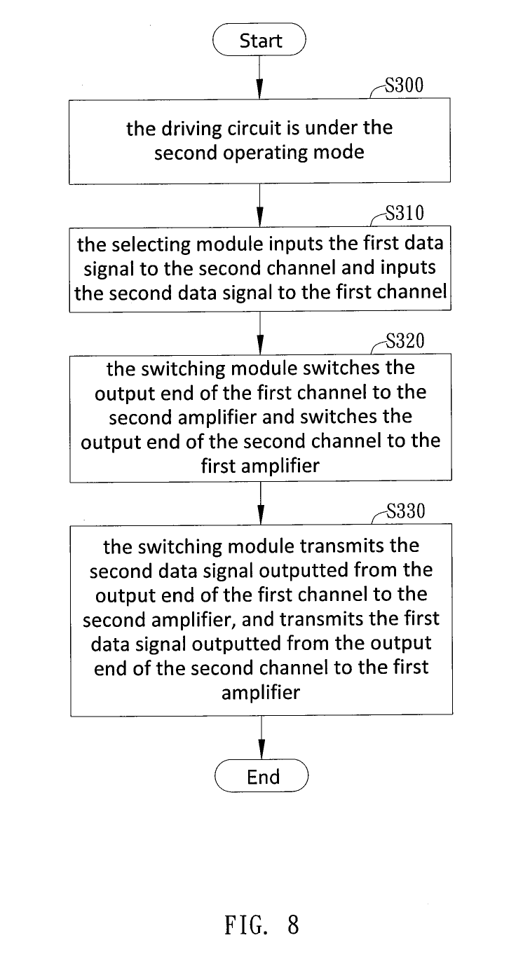

Please refer to FIG. 8. FIG. 8 illustrates a flowchart of the driving circuit operating method when the driving circuit is operated under the second operating mode. As shown in FIG. 8, when the driving circuit is under the second operating mode (step S300), the method performs step S310 that the selecting module inputs the first data signal to the second channel and inputs the second data signal to the first channel. Then, the method performs step S320 that the switching module switches the output end of the first channel to the second amplifier and switches the output end of the second channel to the first amplifier. Afterward, the method performs step S330 that the switching module transmits the second data signal outputted from the output end of the first channel to the second amplifier, and transmits the first data signal outputted from the output end of the second channel to the first amplifier.

Compared to the prior arts, since N-type and P-type DAC modules with smaller area can be used in each channel of the driving circuit of the invention, the conventional CMOS DAC module with larger area can be replaced to largely reduce the area used by each channel to increase the channel density of the driving circuit.

In addition, it is unnecessary to dispose the N-type DAC module and the P-type DAC module with different polarities in two adjacent channels in the driving circuit respectively. The switching module can exchange the data signals only if the channels corresponding to the data signals have different polarities respectively. Therefore, the alignment freedom of the N-type DAC modules and the P-type DAC modules in each channel can be also increased in the driving circuit of the invention.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A driving circuit, comprising:
at least one first channel;
at least one second channel;
a selecting module, coupled to input ends of the first channel and the second channel; and
at least one switching module, coupled to output ends of the at least one first channel and the at least one second channel;
wherein the selecting module and the switching module perform corresponding switching actions to make the driving circuit selectively under a first operating mode or a second operating mode.

2. The driving circuit of claim 1, wherein the first channel comprises an N-type Digital-to-Analog Converter (DAC) and the second channel comprises a P-type DAC.

3. The driving circuit of claim 1, wherein when the driving circuit is under the first operating mode, the selecting module inputs a first data signal to the first channel and inputs a second data signal to the second channel; when the driving circuit is under the second operating mode, the selecting module inputs a first data signal to the second channel and inputs a second data signal to the first channel.

4. The driving circuit of claim 3, further comprising:
a first amplifier, coupled to the switching module; and
a second amplifier, coupled to the switching module.

5. The driving circuit of claim 4, wherein when the driving circuit is under the first operating mode, the switching module switches the output end of the first channel to the first amplifier and switches the output end of the second channel to the second amplifier, the switching module transmits the first data signal outputted from the output end of the first channel to the first amplifier, and transmits the second data signal outputted from the output end of the second channel to the second amplifier.

6. The driving circuit of claim 4, wherein when the driving circuit is under the second operating mode, the switching module switches the output end of the first channel to the second amplifier and switches the output end of the second channel to the first amplifier, the switching module transmits the second data signal outputted from the output end of the first channel to the second amplifier, and transmits the first data signal outputted from the output end of the second channel to the first amplifier.

7. The driving circuit of claim 1, wherein the selecting module is formed by a plurality of multiplexers.

8. A method of operating a driving circuit, the driving circuit comprising at least one first channel, at least one second channel, a selecting module, and at least one switching module, the selecting module being coupled to input ends of the first channel and the second channel, the at least one switching module being coupled to output ends of the at least one first channel and the at least one second channel, the method comprising steps of:
receiving a control signal;
the selecting module and the switching module performing corresponding switching actions according to the control signal; and
the driving circuit being selectively operated under a first operating mode or a second operating mode.

9. The method of claim 8, wherein when the driving circuit is under the first operating mode, the method further comprises steps of:
the selecting module inputting a first data signal to the first channel and inputting a second data signal to the second channel;
the switching module switching the output end of the first channel to a first amplifier and switching the output end of the second channel to a second amplifier; and
the switching module transmitting the first data signal outputted from the output end of the first channel to the first amplifier, and transmitting the second data signal outputted from the output end of the second channel to the second amplifier.

10. The method of claim 8, wherein when the driving circuit is under the second operating mode, the method further comprises steps of:
the selecting module inputting a first data signal to the second channel and inputting a second data signal to the first channel;
the switching module switching the output end of the first channel to a second amplifier and switching the output end of the second channel to a first amplifier; and
the switching module transmitting the second data signal outputted from the output end of the first channel to the second amplifier, and transmitting the first data signal outputted from the output end of the second channel to the first amplifier.
